(19) United States
(12) Patent Application Publication
(10) Pub. No.: US 2004/0215651 A1
(43) Pub. Date: Oct. 28, 2004

(54) Platform for management and mining of genomic data

(76) Inventors: Victor M. Markowitz, Albany, CA (US); Thodoros Topaloglou, Menlo Park, CA (US); Kevin McLoughlin, Oakland, CA (US); John Campbell, Gaithersburg, MD (US); Dmitry Krylov, Rockville, MD (US); I-Min A. Chen, El Cerrito, CA (US); Walter Bogorad, Danville, CA (US); Anthony Kosky, Berkeley, CA (US); Alex Chang, Berkeley, CA (US)

Correspondence Address: JOHN S. PRATT, ESQ, KILPATRICK STOCKTON, LLP, 1100 PEACHTREE STREET, ATLANTA, GA, 30309, US

(21) Appl. No.: 10/481,715

(22) PCT Filed: Jun. 24, 2002
(86) PCT No.: PCT/US02/19877

Related U.S. Application Data
(60) Provisional application No. 60/299,741, filed on Jun. 22, 2001.

(51) Int. Cl. G06F 7/00

(52) U.S. Cl. 707/102

(57) ABSTRACT

A software platform for analyzing gene expression, gene annotation, and sample information in a relational format comprises a gene expression module (200) with a data warehouse (210) for storing quantitative gene expression measurements for tissues and cell lines screened using various assays, information on bio-samples (404) and donors, experimental information, and a gene index comprising curated information from external information sources. A connection module (300) permits loading of more than one source of gene expression, gene annotation into the data warehouse (210) so that it may be searched in combination with pre-existing data in the warehouse. A user interface provides for loading user-derived data, initiating searches and for visualizing search results.

### CROSS-REFERENCE TO RELATED APPLICATIONS

This application claims priority to U.S. provisional application Serial No. 60/299,741, filed on Jun. 22, 2001 and is a continuation-in-part of each of application Ser. No. 09/862,424, filed May 23, 2001, which claims priority to U.S. provisional application Ser. No. 60/206,571, filed May 23, 2000, Ser. No. 10/090,144, filed Mar. 5, 2002, which claims priority to application Ser. No. 09/797,803, filed Mar. 5, 2001, and Ser. No. 10/096,645, filed Mar. 14, 2002, which claims priority to U.S. provisional application Ser. No. 60/275,465, filed Mar. 14, 2001. Each of the related applications is incorporated herein by reference in its entirety for all purposes.

### BACKGROUND OF THE INVENTION

1. Field of the Invention

The present invention relates generally to a computer platform for storing, organizing and retrieving biological information and more specifically to a platform for management and searching of gene expression data and related information from multiple data sources data by multiple users.

2. Description of the Related Art

The study of gene expression brings valuable information to the researcher about cellular function that can be applied directly to drug discovery and development. Devices and computer systems have been developed for collecting information about gene expression or expressed sequence tag (EST) expression in large numbers of tissues.

DNA microarrays are glass or nylon chips or substrates containing arrays of DNA samples, or “probes”, which can be used to analyze gene expression. A fluorescently labeled nucleic acid is brought into contact with the microarray and a scanner generates an image file indicating the locations within the microarray at which the labeled nucleic acids are bound. Based on the identity of the probes at these locations, information such as the monomer sequence of DNA or RNA can be extracted. By profiling gene expression, transcriptional changes can be monitored through organ and tissue development, microbiological infection, and tumor formation. The robotic instruments used to spot the DNA samples onto the microarray a surface allow thousands of samples to be simultaneously tested. This high-throughput approach increases reproducibility and production.

Microarray technologies enable the generation of vast amounts of gene expression data. Effective use of these technologies requires mechanisms to manage and explore large volumes of primary and derived (analyzed) gene expression data. Furthermore, the value of examining the biological meaning of the information is enhanced when set in the context of sample profiles and gene annotation data. The format and interpretation of the data depend strongly on the underlying technology. Hence, exploring gene expression data requires mechanisms for integrating gene expression data across multiple platforms and with sample and gene annotations.

The GeneChip® of Affymetrix, Inc. (Santa Clara, Calif.) is one example of a widely-adopted microarray technology that provides for the high-volume screening of samples for gene expression. Affymetrix also offers a series of software solutions for data collection, conversion to AADM™ (“Affymetrix Analysis Data Model”) database format, data mining and a multi-user laboratory information management system (“LIMS”). LIMS is a microarray data management package for users who are generating large quantities of GeneChip® probe array data. Data are published to a GATC™ (Genetic Analysis Technology Consortium)-standard database which can be searched by mining tools that are GATC-compliant. The Affymetrix technology has become one of the standards in the field, and large databases of gene expression data generated using this technology, along with associated information, have been assembled and are publicly-available for data mining by pharmaceutical, biotechnology and other researchers and clinicians. However, these researchers often have proprietary gene expression data, also generated using the Affymetrix technology, and associated data which they may wish to compare with the existing database for validation, or to combine with the database for expanded searching. Further, the researchers may wish to utilize a specific analysis and visualization tool, or to use multiple such tools for comparison. Accordingly, a system is needed for integrating data from multiple sources and providing multiple options for analyzing the results. The present invention is directed to such a system.

### BRIEF SUMMARY OF THE INVENTION

In an exemplary embodiment, the software platform of the present invention provides integration, management and analysis of large amounts of Affymetrix GeneChip®-based gene expression data from different sources. The inventive platform comprises a gene expression database module arranged as a three-tier client-server application with subcomponents for storing and organizing gene expression data generated and associated clinical and experimental information data in a data warehouse with software for analyzing the data and visualizing the analysis results, and an integration, or connection, module for staging of proprietary data from external files into the data warehouse. A user interface provides access to the gene expression database module through an explorer application of that module as well as through the connection module by way of a launcher application installed at the user's workstation.

The data warehouse database stores quantitative gene expression measurements for tissues and cell lines screened using various assays, experiment data; a clinical database for storing information on bio-samples and donors; and gene annotation data. The integration module includes functions to validate and migrate data into the gene expression database and, where needed, transform data from external files into standard formats that are compatible with the existing data pool.

An optional module linked to the gene expression module comprises a function for accessing expanded and enhanced genomic and proteomic infrastructure using the GenCarta™ system available from Compugen, Ltd. (Tel Aviv, Israel). GenCarta™ maps information from a human transcriptome and proteome database to Affymetrix sequences. The related expression data are stored in the platform's data warehouse.

The gene expression module can be pre-loaded with a large pre-existing database representing a comprehensive survey of gene expression levels of human tissues, cell lines and experimental animal models at a variety of disease, treatment and normal conditions. Alternatively, it can be loaded with a customer's, or custom-generated, gene expression data and sample information transformed and integrated with up-to-date gene annotations resulting in a representation that allows the researcher to use the information to prioritize genes based on expression patterns, e.g., up- or down-regulated in particular processes.

The user interface provides for receiving a query regarding gene expression of one or more DNA fragments and for displaying the results of a correlation of the level of gene expression with the clinical database and the fragment index.

### BRIEF DESCRIPTION OF THE DRAWINGS

The accompanying drawings, which are incorporated in and form a part of the specification, illustrate embodiments of the present invention and, together with the description, disclose the principles of the invention, wherein:

FIG. 1 is a block diagram of a top level view of the inventive software platform;

FIG. 2 is a block diagram of the gene expression module of the inventive software platform;

FIG. 3 is a block diagram of the connector module of the inventive software platform;

FIG. 4 is a more detailed block diagram showing data flow through the connector module;

FIG. 5 is a portion of an exemplary XML sample data file;

FIG. 6 is a block diagram showing customer data migration into and storage in the data warehouse.

### DETAILED DESCRIPTION OF THE PREFERRED EMBODIMENT

In general, the present invention comprises an enterprise-wide software platform for gene expression research. In the exemplary embodiment, the system provides integration, management and analysis of large amounts of Affymetrix GeneChip®-based gene expression data from different sources. The system includes capabilities for capturing and analyzing associated clinical and experimental information. The system accepts data from the major Affymetrix GeneChip® types across various species and can accommodate custom chips.

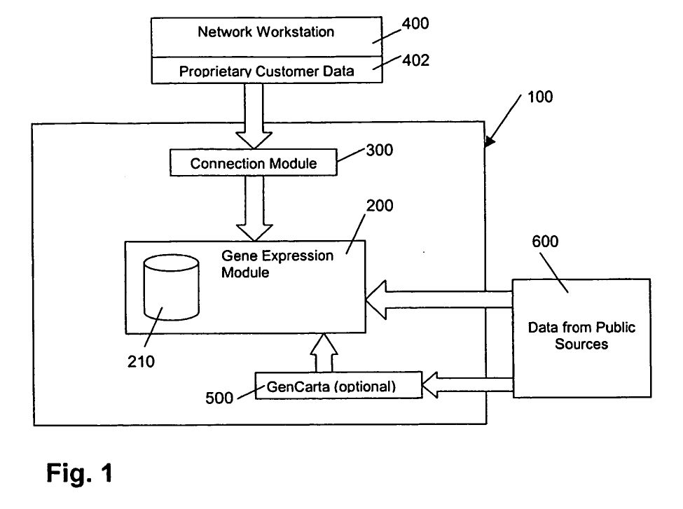

As illustrated in FIG. 1, the inventive software platform 100 comprises a gene expression module 200, a connection module 300, and a user interface 400 comprising a network workstation, which includes means for entry of customer data 402. Optional module 500 provides access to the GenCarta™ transcriptome database system from Compugen, Ltd. (Tel Aviv, Israel). Both gene expression module 200 and the GenCarta system include means for extraction of data from public sources 600 such as Genbank, SwissProt, LocusLink, Unigene, KEGG, SPAD, PubMed, HUGO, OMIM and GeneCard. This list is not intended to be exhaustive, and other sources, both private and public, may be used.

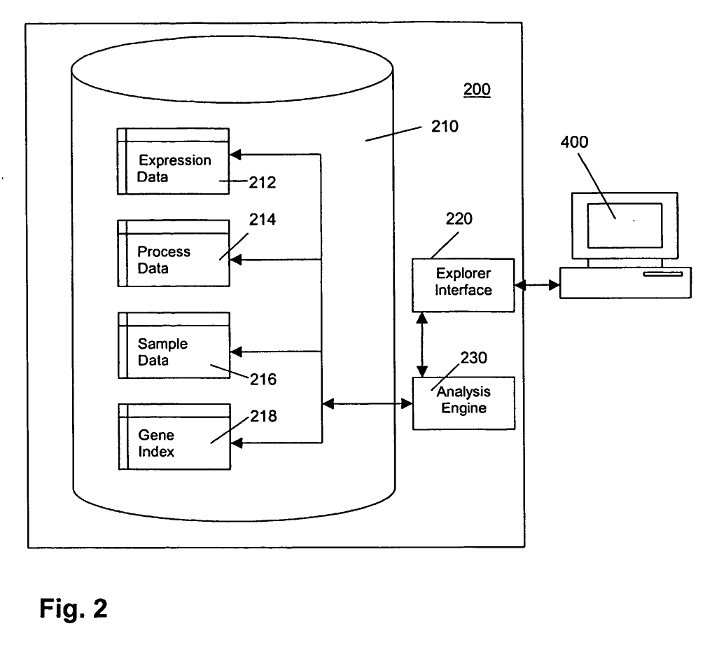

Referring now to FIG. 2, gene expression module 200, available commercially as the GeneExpress® software system, comprises a three-tier client-server application with several sub-components. The data warehouse 210 is an Oracle®-based warehouse which maintains a large collection of data. Data warehouse 210 comprises summarized and curated gene expression data, integrated with sample and gene annotation data, and provides support for effective data exploration and mining. The data in the collection are partitioned into several databases. The gene expression database 212 contains a large volume of gene expression data in GATC/AADM compliant formats. Process database 214 stores information which characterizes and is related to the gene expression data in database 212, including information on experiment set grouping, QC data, and experimental conditions under which the gene expression data was generated. Sample database 216 stores sample or clinical data that include bio-samples, donors and standardized terms that describe the samples. Sample data can be organized by static controlled vocabulary classes such as type, species, organ, clinical and demographic data, lifestyle factor, treatment outcome, etc., or can be organized into experimental study groups, SNOMED disease term and code, SNOMED organ term and code, etc. Templates are preferably used to standardize the organization of the sample data.

Gene index database 218 stores annotations which can be used to uniquely identify the gene expression data stored in database 212. The gene index database 218 links each gene fragment with existing annotations of the gene contained in public databases such as Genbank, SwissProt, LocusLink, Unigene, KEGG, SPAD, PubMed, HUGO, OMIM and GeneCard, all of which are known in the art. In linking the gene fragment with existing databases, the inventive system maintains recognized biological meaning and identity, thus avoiding redundancy, ambiguity or errors. The gene fragments can also be linked in gene index database 218 to chromosomes and to biological pathways such as the protein signaling pathways available from BioCarta, Inc. (San Diego, Calif.).

Explorer interface 220 is a Java-based workspace application that provides the end-user interface to the system for user interface 400. User access to gene expression module 200 is limited to entry of search queries and a read-only function, which allows the a user to view data stored in the data warehouse 210 that is identified as the result of the search. The explorer interface 220 provides analysis and visualization tools, and also provides seamless integration with other popular tools. Explorer interface 220 also keeps track of a user's research and analysis activities, including selected sample or gene sets and analysis results, for later retrieval through a workspace manager.

Analysis engine 230, also referred to as the “Run time engine” or “RTE”, is a server-based engine that is optimized for performing the core functional and computational duties within gene expression module 200. Analysis engine 230 communicates and links between the explorer interface 220 and the data warehouse 210 while providing the primary power for all complex analysis tasks. Connector module 300 permits a user to load more than one source of gene expression, and sample information in the data warehouse 210 of gene expression module 200. In particular, connector module 300 permits a system user to load the user's expression data and sample data from external files into the data warehouse for comparison or combination with a pre-existing, internally-stored set of data, i.e., the data already existing in data warehouse 210. To facilitate distinction between the different data sources, the latter data may be referred to as the “pre-existing data” while the user's data will be referred to as “customer data”. Connector module 300 provides an interactive interface to manually add and edit sample data through a sample data manager, which provides validation and migration of sample data from external files into the system. A XML sample migration template facilitates preparation of sample data for migration. After the expression and sample data have been loaded via the connector module 300, the user can view, query and analyze his/her own data together with the pre-existing data.

The connector architecture preferably is object-oriented so components can be developed and modified individually. Wherever possible, schema-dependent rules and logic are stored outside the code so that schema changes can be readily made without affecting the code.

The connector database and server components preferably run on hardware from Sun Microsystems, Inc. (Palo Alto, Calif.) on the Solaris™8 Operating Environment (also from Sun Microsystems). The database is Oracle Server 8.1.7.3. Other software includes Visibroker® C++ 3.3.2 from Borland Software Corporation (Scotts Valley, Calif.), Java 2 SDK version 1.3.1.03 (available on the WWW from Sun Microsystems), Apache HTTP server 1.3.12 and Xerces-c 1.7.0 XML parser (both from Apache Software Foundation at www.apache.org), Expat 1.95.2 XML parser library (available from http://sourceforge.net), and Perl 5.6.0 and 5.6.1. For any of the identified software, later version may be used as well. Supporting documentation for the hardware and each of the listed software programs is incorporated herein by reference for purposes of this disclosure.

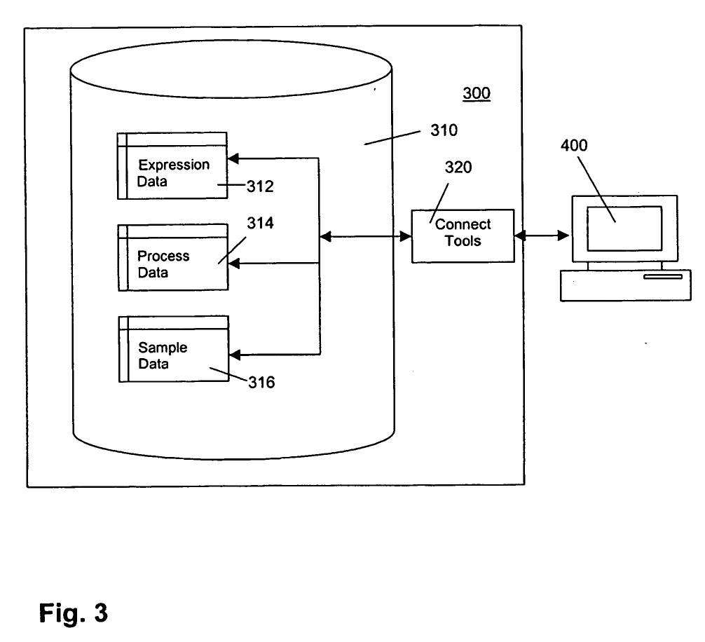

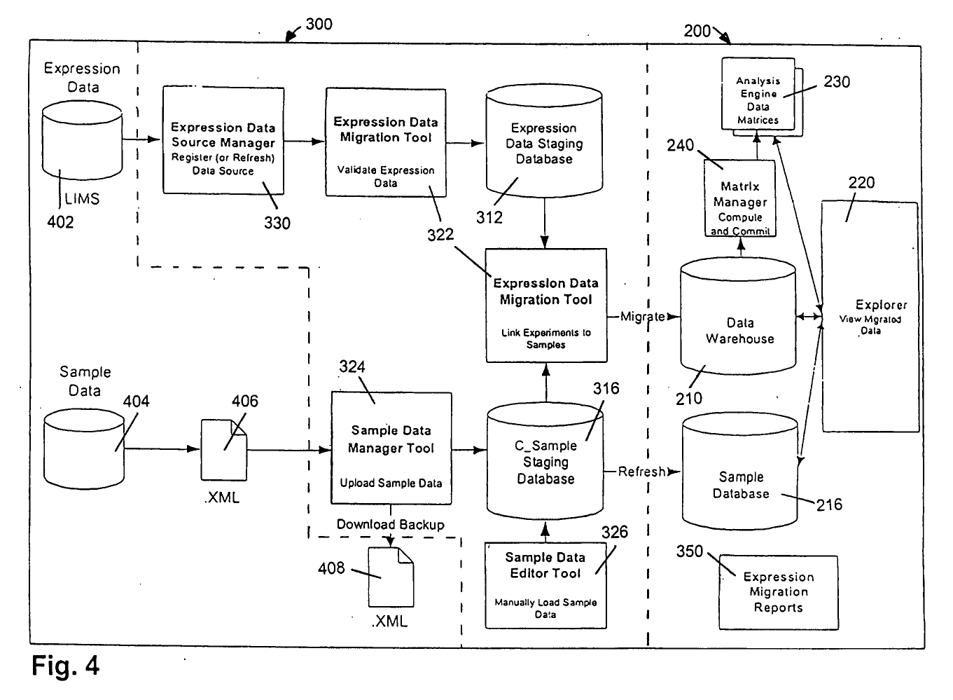

Referring to FIG. 3, the basic architecture of connector module 300 is illustrated and includes connector data staging platform 310 which is partitioned into three different databases. Connector expression data manager 312 stages user-selected expression data from GATC/AADM external sources for migration into data warehouse 210. Expression data manager 322 (in FIG. 4) provides validation, transformation and migration of expression data into the data warehouse 210. Data within expression staging database 312 is transient. D values are offset to eliminate clashes between existing data and customer data.

Connector sample database 316 stages customer samples loaded from a XML file prior to loading into sample database 216 of data warehouse 210. The user's sample data is preferably drawn from a pre-defined sample template in XML format. The connector module provides a function allowing the user to enter or modify the user sample data using the sample data editor. Database 316 also serves as the underlying database for a sample data editor which allows the user to enter new sample data or to revise customer sample data entered through XML file loading.

Database 316 is persistent (not transient). However, each sample template data loading from an XML file will overwrite existing sample data in the sample staging database. Therefore, the sample staging database contents should be backed up before each new XML data loading. Therefore, a user can always recover the sample staging database should he/she make a mistake. Certain data are classified static-dynamic. This data is moved into the data warehouse only if it does not already exist in the warehouse. If it does exist, the reference to it in the customer data is synchronized with what already exists in the warehouse. Such data includes TARGET_TYPE, and PROTOCOL_TEMPLATE.

Connector process database 314 stores detailed references to the customer's expression (LIMS) and sample data, configuration information and event logs for all processes performed within the connection module. Data stored in this database is persistent. However, deleting LIMS source or unmigrating experiments will cause the corresponding data to be removed from the connector process database 314. References to static data are synchronized in customer data to the gene expression module so that both use the same ID value for a given name.

The user interface 400 communicates with the connection module 300 to provide the user with the ability to perform expression and sample data loading. The connection module 300 also communicates proper status information, messages and viewing functions to the user via the user interface 400.

Operations by connection module 300 only affect operation of the gene expression module 200 when data is migrated into the data warehouse 210 and the analysis engine (RTE) is synchronized. This is due to the fact that the connection processes are usually relatively long-running. When this occurs, all users who are connected with the gene expression module 200 will be required to restart their application.

FIG. 4 provides a more detailed diagram of the functions performed by connector module 300, including a number of connection tool functions. Gene expression data from data source 402 is loaded through a user interface (not shown) which may include a network workstation or may be a separate station in a laboratory system having an Affymetrix LIMS Oracle database. If the user's expression data are in other (compatible) types of systems or flat files, then the data is preferably downloaded, processed and uploaded into a LIMS Oracle database. The gene expression data enters module 300 through the expression data source manager 330 which acts to register data source 402 and extract a list of experiments from this data source. Expression data source manager 330 includes the ability to refresh the experiment list of a registered expression data source 402. Expression data migration tool 322 is used to validate expression data, create links between experiments and samples, queue data for migration and migrate the expression data into the data warehouse 210. Expression data staging database 312 acts as a staging area for expression data during operation of data migration tool 322.

Sample data 404 is preferably entered into a pre-defined sample template 406 in XML format, and then if uploaded into the sample staging database 316 using the sample data manager tool 324. This tool is used to upload, refresh and backup sample data. As described above, because each sample template data loading from an XML file overwrites existing sample data in the sample staging database, the existing sample database content is backed up in an XML data file 408. If necessary, the user can access overwritten sample data via XML data file 408. All tables representing customer sample data are truncated during XML file upload. (Tables for controlled vocabularies and ID mapping information are not truncated.) Sample data manager tool 324 uploads the XML data file into the sample staging database 316 by parsing with a Perl XML parser. The XML parser also verifies the correctness of the sample data file. If the XML data file passes the syntax checking and validation, then Oracle SQL Loader control and data files will be generated for bulk loading customer sample data into the sample staging database 316.

Customer sample data in the sample staging database 316 is downloaded into the sample template XML format using a Perl script which takes a control file to download customer sample data in the database into an output XML file. All customer sample data in sample staging database 316 is preserved in the XML output file. However, the XML output file may not be identical to the original sample template XML file because some attributes with null values can be assigned with default values in database 316 by the loader.

Sample staging database 316 serves as a staging area for storing sample data prior to migration and for refreshing sample data in the gene expression sample database 216. Links between sample data and expression data are staged in the expression data staging database 312. (Note that although sample database 216 is preferably encompassed within data warehouse 210, it been shown as having distinct structure from the data warehouse to facilitate illustration of the different handling of the migrating sample data.) Sample data editor tool 326 is used to manually enter sample data, and to edit sample data that may have originally been uploaded as an XML file.

In operation of connector module 300, there are 6 major steps to be performed in loading of customer expression data:

1. Register and initialize (or refresh) an expression data source: This function is handled in expression data source manager 330. A user first registers an expression data source Oracle database, e.g., database 402, by entering the Oracle database information (TNS name, host name, port number and/or SID) and user logon information (user name and password). All experiments in this Oracle database will be recorded in a master experiment list. When new experiments have been added to a registered expression data source, a user can refresh the master experiment list for this data source.

2. Extract and validate selected experiments into the staging database: This operation is performed by expression data migration tool 322. A user selects a list of experiments from a registered expression data source. All experiments in the same batch come from the same expression data source. However, a user may also be allowed to select experiments from different expression data sources in different batches. All expression data sources should be registered by expression data source manager 330 first. All selected experiments are preferably validated by expression data migration tool 322 to determine whether the data are “complete”. All validated experiments are staged in the expression data staging database 312 for further operations. Proper ID value transformation is performed before data are loaded into the expression data staging database 312 to ensure that the user expression data and the standardized expression data are using different ID spaces.

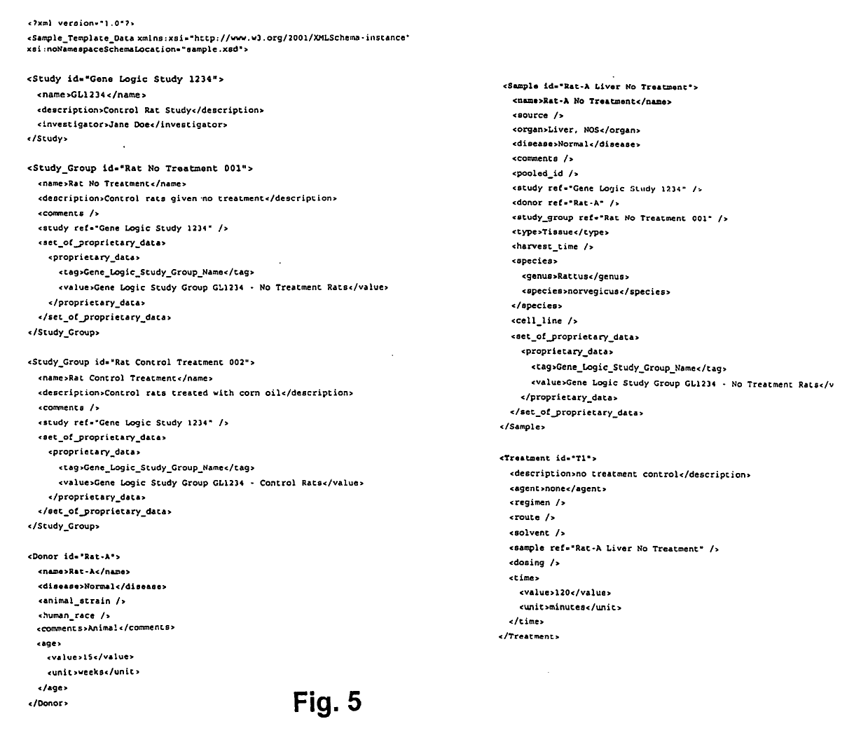

3. Upload sample data and link experiments with sample data: Sample data 404 is preferably uploaded via sample XML file 406 via the sample data manager tool 324. A portion of an exemplary sample XML file is provided in FIG. 5. Alternatively, the sample data can be manually entered via sample data editor tool 326, for example, if a relatively small amount of data is to be loaded, or the data are not in a database but are taken directly from lab notebooks. Once uploaded, the sample data is staged in sample data staging database 316 until it is linked with the experiments by expression data migration tool 322. Each experiment is preferably associated with only one sample, however, multiple experiments may be linked to the same sample.

4. Migrate the data into the data warehouse: This function is carried out by expression data migration tool 322 after the sample-experiment links are completed. Only validated and linked (to sample) experiments can be migrated into the data warehouse. The migrated experiment data will also be loaded to the analysis engine 230 or Run Time Engine (“RTE”) in gene expression module 200. An “un-migrate” operation is provided to allow a user to remove migrated experiments from the data warehouse 210 and the analysis engine 230.

Different migration strategies may be used depending on the size of the databases. For migration of sample data into sample database 216, the size of the connect sample database and the sample database in gene expression module 200 is relatively small. Therefore, a full refresh is performed for each migration as follows: mapping between the connector sample and the pre-existing sample objects is done for all connector sample objects. Next, data is retrieved from the connector sample database 316 based on a metadata control file and SQL (structured query language) loader files are generated for loading into sample database 216. All customer data in sample database 216 are removed using SQL delete statements. (The customer data in sample database 216 is offset with predetermined ID ranges.) The customer sample data is loaded into sample database 216 using Oracle SQL loader.

Because gene expression data and process data databases may both be relatively large, no full refresh is performed. Only user validated and linked experiments are migrated into the data warehouse 210.

5. Compute and commit migrated data: This operation takes place in matrix manager 240 of gene expression module 200. In order for the migrated data to be available to the explorer interface 220, the analysis engine 230 must be refreshed using the matrix manager 240. Matrix manager 240 refreshes the expression data in the analysis engine 230 and copies the expression data that have been computed into the analysis engine 230.

6. Viewing migrated data in the explorer interface: At the completion of the migration process, migrated data are available within the explorer interface 220. At this point, migrated data can be queried, saved and analyzed just like other pre-existing data in the data warehouse 210 by way of the user interface and selection of the desired option.

Additional information about the connection process is available through expression migration reports 350. This function is primarily administrative, for tracking the status of migration operations and includes filtering options for selecting specific information such as the type of operations performed, types of samples migrated, donors, study groups, etc. The administrator can also check on the system function and status, including Java RMI server activity, RTE information, e.g., refreshes and updates, database synchronization, etc.

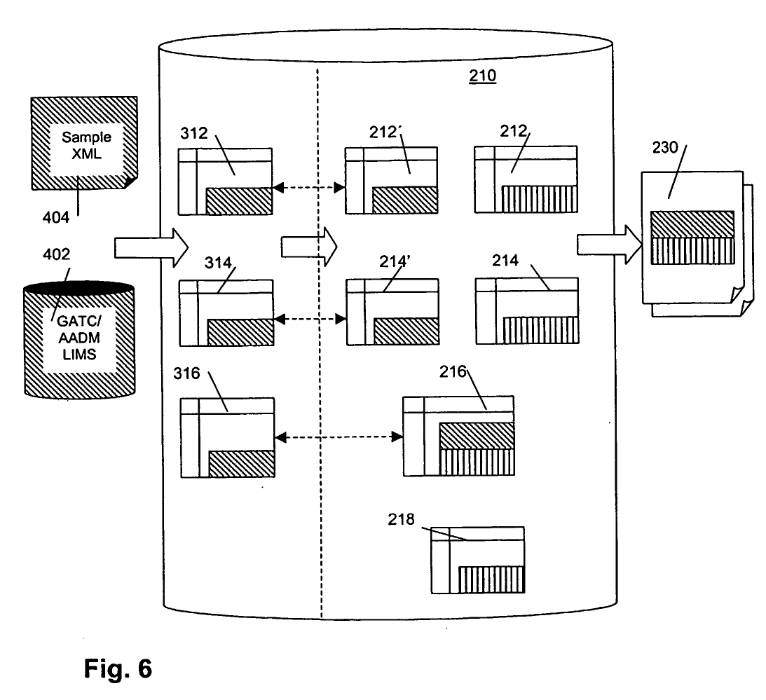

After migration of data into data warehouse 210, the pre-existing expression data and customer expression data reside in different database partitions. As illustrated in FIG. 6, customer data is designated by angled fill lines while pre-existing data is designated by vertical fill lines. Customer gene expression data 402 and sample data 404 migrates into the data warehouse 210 through staging databases 312 and 316 in connection module 300. Customer process data is loaded through process staging database 314. After migration, the customer's gene expression data is maintained in data warehouse 210 as a separate expression data file 212′ from pre-existing expression data file 212, even though, for purposes of analysis, the analysis engine 230 will look to both for data to satisfy a search query. Accordingly, the data matrix within analysis engine 230 is illustrated as containing data corresponding to a combination of both customer and pre-existing data.

By maintaining a partition between the pre-existing data and the customer data within data warehouse 210, the pre-existing data can be updated or modified while the customer's expression data remains intact. Also, the customer's proprietary data is not merged into the broader database in a way that might be accessible to other customers.

In a similar manner, the customer process data from process staging database 314 is maintained in a separate database 214′ from the pre-existing process database 214.

Customer sample data from staging database 316 is combined with pre-existing sample data in database 216. No customer data is combined with gene index 218; all of the information contained in this database is pre-existing relative to the customer's data.

The data matrices within analysis engine 230 are managed by the matrix manager 240 (shown in FIG. 4). Matrix manager 240 merges data by creating a union of corresponding matrices from two sets of data. The merging is performed when customer data is migrated into the data warehouse, to combine pre-existing data with the customer data. The merge also occurs when the pre-existing data is updated, for example by adding new data. Any of the four databases within data warehouse 210 can be updated. Matrix manager 240 takes into consideration the sample IDs that have been assigned to customer data and the old pre-existing data so that when new data is added to the pre-existing database, the new data will take precedence over the customer data and the old pre-existing data. For example, if there are samples with the same sample IDs, the expression and call values in the unioned matrices will be from the sample with higher precedence.

Referring briefly to FIG. 1, access to functions of the inventive software platform is initiated using a launcher which is downloaded on each network workstation 400 on which a user wishes to utilize the platform's capabilities. The software platform is intended to be accessed from and used by multiple workstations.

The network workstation is preferably a 500 MHz Pentium III (or faster) processor running Windows NT 4.0 or later with at least 50 MB of free hard drive space, 256 MB of RAM and virtual memory set to 256 MB; a color monitor with at least 1024×864 pixels and 256 colors (1152×864 pixels and 65536 colors are recommended); Netscape Navigator (version 4.7) or Internet Explorer (version 5.0 or later); a workspace account; and a Java Runtime Environment (JRE), preferably version 1.3.0 or later.

In addition, other commercially software packages are preferably available to augment the present invention, including Spotfire® Pro (version 4.0 or later) and Spotfire® Array Explorer, both marketed by Spotfire Corporation (Cambridge, Mass.) for visual examination of gene data exploration results; or Microsoft® Excel 2000®; Eisen Cluster Tool; GeneSpring® from Silicon Genetics (San Carlos, Calif.); S-plus®, from Mathsoft Corporation (Seattle, Wash.); or Partek® Pro 2000, etc. for analysis with statistical tools.

Those skilled in the art should appreciate that the present invention may be implemented over a network environment. The network may be any one of a number of conventional network systems, including a local area network (“LAN”), a wide area network (“WAN”), or the Internet, as is known in the art (e.g., using Ethernet, IBM Token Ring, or the like). In addition, the present invention may also use data security systems, such as firewalls and/or encryption.

To install the application of the present invention, a user points his/her Web browser to the URL (universal resource locator) providing the home page of the present invention. The user can then select the download option, which opens the download and installation page of the present invention. Among other things, this page provides instructions for completing the two steps for installing the application of the present invention: installing the Java Runtime Environment and installing the launcher for the inventive software.

Over time, a user of the application of the present invention will develop a large number of sample sets, gene sets, and analysis results. The application of the present invention preferably incorporates a workspace which serves as a centralized repository for these data objects, organized into user-defined project folders. Access to the workspace is preferably controlled through user names, user group affiliations, and passwords. User-defined data objects are by default private to the user; however, during the save process, the user preferably has the option of making data objects accessible to other users.

The relational database of the present invention preferably utilizes a three-layer archiving system. The three layers are: (1) an on-line network disk file system; (2) near-line storage; and (3) off-line DLT tape backups. The on-line network disk file system is based on a network disk system (Network Appliance F720). The network file system is also visible to the NT network. The disk space is organized into two partitions: one for archiving and one for building data distributions. A complete set of information for each sample in a file system accessible from both UNIX and Windows® is maintained. The information is organized by genomics identification number and can be further broken down by experiment name. By storing the information in this directory structure, it is easier to build distribution sets based on filtering requirements. The near-line storage is based the HP Superstore magneto-optical jukebox and serves as the backup device of all data files generated by production and is also the backup of the on-line archive.

Off-line DLT tape backups are used to backup the pre-staging directories, the database servers and the on-line archive.

The software platform of the present invention performs certain functions that are disclosed in more detail in the related applications, which have been incorporated herein by reference. For example, the detailed operation of the gene expression analysis engine, including the analysis algorithms, is disclosed in application Ser. Nos. 09/862,424, 09/797,803, and 10/096,645. The detailed function of the connection module is disclosed in application Ser. No. 10/096,645. The inventive software platform provides integration, management and analysis of large amounts of gene expression data from different sources. It provides extensive capabilities for capturing and analyzing associated clinical and experimental information. The system further provides curated public and proprietary information about the genes represented on the microarrays, adding instantaneous biological context to the expression data. Gene information includes data obtained from a large number of public databases. The connection capability of the software platform enable the combination of multiple data sources, giving researchers the ability to analyze their own data in light of an extensive database.

Various preferred embodiments of the invention have been described in fulfillment of the various objects of the invention. It should be recognized that these embodiments are merely illustrative of the principles of the invention. Numerous modifications and adaptations thereof will be readily apparent to those skilled in the art without departing from the spirit and scope of the present invention.

What is claimed is:

1. A software platform for integrating, managing and analyzing gene expression data and associated information, the software platform comprising:
a gene expression module comprising a data warehouse comprising a gene expression database for storing quantitative gene expression measurements for tissues and cell lines; a sample database for storing information on bio-samples and donors associated with the tissues and cell lines; and process database for storing information about experiments performed on the tissue and cell lines; a gene index for storing information obtained from external sources about genes of interest, and an analysis engine for analyzing gene expression data in the data warehouse;
a connection module in communication with the gene expression module and comprising a plurality of staging databases for customer-supplied gene expression data, sample data and process data and a migration manager for controlling migration of customer-supplied data into the data warehouse; and
a user interface for entering and receiving a response to a query for analysis of data within the data warehouse and for uploading customer-supplied gene expression data, sample data and process data into the connection module for migration into the data warehouse.

2. The software platform of claim 1, the gene expression module further comprising a data manager for maintaining a partition between migrated customer-supplied data and data pre-existing within the data warehouse.

3. The software platform of claim 2, wherein the data manager updates the pre-existing data in data warehouse without modification of the customer-supplied data.

4. The software platform of claim 2, wherein the data manager further combines migrated customer-supplied data and pre-existing data for analysis by the analysis engine.

5. The software platform of claim 1, wherein the connection module permits registering of more than one source of customer-supplied gene expression and sample information and extraction of a list of experiments from the more than one source of gene expression and sample information.

6. The software platform of claim 5, wherein the connection module provides for refreshing of the list of experiments from the more than one source of gene expression and sample information.

7. The software platform of claim 5, wherein the connection module permits checking for consistency the more than one source of gene expression and sample information.

8. The software platform of claim 1, wherein the connection module includes a XML parser for entering customer sample data into a XML template.

9. The software platform of claim 8, wherein the connection module provides a download back-up for preserving customer-entered sample data.

10. The software platform of claim 1, wherein the connection module includes a sample data editor for manually entering new customer sample data

11. The software platform of claim 1, wherein the connection module includes a sample data editor for editing or updating customer sample data that was previously entered.

12. The software platform of claim 1, wherein the connection module includes a migration tool for linking customer-supplied experiment data to customer-supplied sample data.

13. The software platform of claim 1, wherein the connection module includes a migration tool for validating customer-supplied gene expression data prior to migration into the data warehouse.

14. The software platform of claim 1, further comprising a GenCarta module for accessing a transcriptome database for providing information about genes represented by the gene expression data, sample data and process data.

15. A software platform for integrating, managing and analyzing gene expression data and associated information, the software platform comprising:
a gene expression module comprising:
a data warehouse comprising a gene expression database for storing quantitative gene expression measurements for tissues and cell lines; a sample database for storing information on bio-samples and donors associated with the tissues and cell lines; and process database for storing information about experiments performed on the tissue and cell lines; a gene index for storing information obtained from external sources about genes of interest, and
an analysis engine for analyzing gene expression data in the data warehouse;
a connection module in communication with the gene expression module, the connection module comprising:
a plurality of staging databases for customer-supplied gene expression data, sample data and process data; and
a migration manager for controlling migration of customer-supplied data into the data warehouse;
a XML template for entry of sample data; and
a sample data tool for uploading customer-supplied sample data,
wherein the migration manager links customer-supplied experiment data to customer-supplied sample data;
a user interface for entering and receiving a response to a query for analysis of data within the data warehouse and for uploading customer-supplied gene expression data, sample data and process data into the connection module for migration into the data warehouse.
